(19) United States
(12) Patent Application Publication
(10) Pub. No.: US 2025/0093064 A1
(43) Pub. Date: Mar. 20, 2025

(54) SYSTEMS AND METHODS FOR CONTROLLING OPERATION OF A HEATING,VENTILATION, AND AIR CONDITIONING (HVAC) SYSTEM

(71) Applicant: Carrier Corporation, Palm Beach Gardens, FL (US)

(72) Inventor: Ron Kielkowski, Indianapolis, IN (US)

(21) Appl. No.: 18/827,702

(22) Filed: Sep. 7, 2024

Related U.S. Application Data
(60) Provisional application No. 63/583,372, filed on Sep. 18, 2023.
(60) Provisional application No. 63/583,377, filed on Sep. 18, 2023.

(51) Int. Cl. F24F 11/63

(52) U.S. Cl. CPC F24F 11/63

(57) ABSTRACT

Embodiments of the disclosure describe systems and methods for controlling operation of a heating, ventilation, and air conditioning (HVAC) system. The HVAC system comprises a thermostat and a first HVAC unit coupled via a power line. The method comprises receiving, by a first control device of the first HVAC unit, from the thermostat over the power line, a HVAC signal associated with an operation to be performed by the HVAC system, wherein the power line is configured to communicate power signal and data signal. The method further comprises determining, by the first control device, whether the HVAC signal received over the power line is indicative of the power signal or the data signal. The method further comprises upon determining that the HVAC signal is indicative of the data signal, triggering, by the first control device, a control action associated with the HVAC system.

### CROSS REFERENCE TO RELATED APPLICATION

This application claims the benefit of U.S. Provisional Patent Application No. 63/583,372 filed on Sep. 18, 2023, and U.S. Provisional Patent Application No. 63/583,377 filed on Sep. 18, 2023, the contents of which is incorporated by reference herein in its entirety.

### FIELD OF THE INVENTION

The disclosure generally relates to heating, ventilation, and air conditioning (HVAC) systems, and more particularly relates to systems and methods for controlling operation of an HVAC system based on power line communication.

### BACKGROUND

Generally, HVAC systems comprise indoor units and outdoor units. The indoor units and outdoor units may be controlled via a thermostat. In order for operation of the indoor and outdoor units, wirings are installed between the thermostat, the indoor unit, and the outdoor unit. The wirings may correspond to operational functions that are to be performed by the indoor unit and/or the outdoor unit.

Referring to FIG. 1, an arrangement 100 of thermostat 102 and a HVAC unit 104 is depicted, in accordance with existing art. The unit 104 may be an indoor unit or an outdoor unit. The thermostat 102 is coupled to the unit 104, in that, multiple wirings 106 are installed between the thermostat 102 and the unit 104. In particular, each wire of the wirings 106 may correspond to an operational function of the unit 104. For instance, functions W1, W2, G, Y2, O/B, and ACC1 may each have a corresponding wire between the thermostat 102 and the unit 104. When a function is to be activated on the unit 104, the corresponding wire is energized by the thermostat 102.

Nowadays, there is an increased interest in installation of additional units, such as heat pumps. Already installed HVAC systems generally rely on a two-wire interface (Y and C lines) for controlling the unit 104. Further, the number of signal connectors (wirings) are set in the already installed HVAC units. Installation of additional units with additional signal connectors would require installation of wirings for the additional signal connectors. However, installation of wirings in an already installed HVAC system is inconvenient and time-consuming. For instance, installation of new wirings may require tearing of walls, digging under walls, or other time-consuming activities to ensure the proper electrical control signals are available to the new unit being installed.

Moreover, time-consuming installation tasks are also inconvenient for technicians. With an increase in demand for more energy efficient equipment (heat pump, multi-stage air conditioners, furnaces, and the like), the demand for additional wirings would also increase.

Therefore, it would be advantageous to provide a solution that can overcome the above-discussed problems.

### SUMMARY

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

Disclosed herein is a method for controlling operation of a heating, ventilation, and air conditioning (HVAC) system. The HVAC system comprises a thermostat and a first HVAC unit coupled via a power line. The method comprises receiving, by a first control device of the first HVAC unit, from the thermostat over the power line, a HVAC signal associated with an operation to be performed by the HVAC system, wherein the power line is configured to communicate power signal and data signal. The method further comprises determining, by the first control device, whether the HVAC signal received over the power line is indicative of the power signal or the data signal. The method further comprises upon determining that the HVAC signal is indicative of the data signal, triggering, by the first control device, a control action associated with the HVAC system.

In one or more embodiments, triggering the control action comprises determining, based on the data signal, the operation to be performed by the HVAC system. Further, the method comprises generating a switching signal to cause at least one of an activation or a deactivation of one or more terminals associated with the first HVAC unit in order to facilitate the operation to be performed by the HVAC system.

In one or more embodiments, triggering the control action comprises determining, based on the data signal, the operation to be performed by the HVAC system. Further, the method comprises causing at least one of an activation or a de-activation of one or more relays of a first set of relays associated with the first HVAC unit.

In one or more embodiments, the HVAC system comprises a second HVAC unit. To trigger the control action, the method comprises determining, based on the data signal, the operation to be performed by the HVAC system. Further, the method comprises causing at least one of an activation or a de-activation of one or more of a second set of relays associated with the second HVAC unit.

In one or more embodiments, triggering the control action comprises determining, based on the data signal, the operation to be performed by the HVAC system. Further, the method comprises converting the data signal into another data signal indicative of a command for the second HVAC unit. Further, the method comprises transmitting, over the power line, the another data signal to the second control device of the second HVAC unit. Furthermore, the method comprises enabling the second control device to at least one of activate or deactivate, based on the another data signal, one or more terminals associated with the second HVAC unit in order to facilitate the operation to be performed by the HVAC system.

In one or more embodiments, triggering the control action comprises simultaneously receiving, by the first control device and the second control device over the power line, the HVAC signal associated with the operation to be performed by the HVAC system. Further, the method comprises generating, by the first control device and the second control device, a first switching signal and a second switching signal respectively to cause at least one of an activation or a deactivation of one or more respective terminals associated with the first HVAC unit and the second HVAC unit, in order to facilitate the operation to be performed by the HVAC system.

In one or more embodiments, the power line is associated with a powered state and an unpowered state. In one or more embodiments, the power line is configured to communicate the data signal in the powered state and in the unpowered state.

In one or more embodiments, the first HVAC unit is an indoor unit (IDU) associated with the HVAC system and the second HVAC unit is an outdoor unit (ODU) associated with the HVAC system.

In one or more embodiments, the power line comprises at least one of a common (C) line and an outdoor activation (Y) line.

Also disclosed herein is a system for controlling operation of a heating, ventilation, and air conditioning (HVAC) system. The system comprises a thermostat and a first HVAC unit coupled to the thermostat via a power line. The first HVAC unit comprises a first control device configured to receive, from the thermostat over the power line, a HVAC signal associated with an operation to be performed by the HVAC system. The power line is configured to communicate power signal and data signal. The first control device is further configured to determine whether the HVAC signal received over the power line is indicative of the power signal or the data signal. The first control device is further configured to trigger a control action associated with the HVAC system upon the determination that the HVAC signal is indicative of the data signal.

In one or more embodiments, to trigger the control action, the first control device is further configured to determine, based on the data signal, the operation to be performed by the HVAC system. Further, the first control device is configured to generate a switching signal to cause at least one of an activation or a deactivation of one or more terminals associated with the first HVAC unit in order to facilitate the operation to be performed by the HVAC system.

In one or more embodiments, to trigger the control action, the first control device is further configured to determine, based on the data signal, the operation to be performed by the HVAC system. Further, the first control device is configured to cause at least one of an activation or a de-activation of one or more relays of a first set of relays associated with the first HVAC unit.

In one or more embodiments, to trigger the control action, the first control device is further configured to determine, based on the data signal, the operation to be performed by the HVAC system. Further, the first control device is configured to cause at least one of an activation or a de-activation of one or more of a second set of relays associated with the second HVAC unit.

In one or more embodiments, the HVAC system comprises a second HVAC unit associated with a second control device. To trigger the control action, the first control device is configured to determine, based on the data signal, the operation to be performed by the HVAC system. Further, the first control device is configured to convert the data signal into another data signal indicative of a command for the second HVAC unit. Further, the first control device is configured to transmit, over the power line, the another data signal to the second control device of the second HVAC unit. Further, the first control device is configured to enable the second control device to at least one of activate or deactivate, based on the another data signal, one or more terminals associated with the second HVAC unit in order to facilitate the operation to be performed by the HVAC system.

In one or more embodiments, to trigger the control action, the first control device is further configured to receive, over the power line, the HVAC signal associated with the operation to be performed by the HVAC system, and generate a first switching signal to cause at least one of an activation or a deactivation of one or more respective terminals associated with the first HVAC unit, in order to facilitate the operation to be performed by the HVAC system. Further, the second control device is configured to simultaneously receive, over the power line, the HVAC signal associated with the operation to be performed by the HVAC system, and generate a second switching signal to cause at least one of an activation or a deactivation of one or more respective terminals associated with the second HVAC unit, in order to facilitate the operation to be performed by the HVAC system.

In one or more embodiments, the power line is associated with a powered state and an unpowered state. In one or more embodiments, the power line is configured to communicate the data signal in the powered state and in the unpowered state.

In one or more embodiments, the first HVAC unit is an indoor unit (IDU) associated with the HVAC system and the second HVAC unit is an outdoor unit (ODU) associated with the HVAC system.

In one or more embodiments, the power line comprises at least one of a common (C) line and an outdoor activation (Y) line.

To further clarify the advantages and features of the methods, systems, and apparatuses, a more particular description of the methods, systems, and apparatuses will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1 illustrates an arrangement of a thermostat and an HVAC unit, in accordance with existing art;

FIG. 2 illustrates an environment comprising a system for controlling operation of an HVAC system associated with one or more HVAC units, in accordance with one or more embodiments of the disclosure;

FIGS. 3A-3B illustrate a block diagram depicting components of a first control device and a second control device, respectively, in accordance with one or more embodiments of the disclosure;

FIGS. 4-7 illustrates schematic representations of a HVAC system, in accordance with one or more embodiments of the disclosure;

FIG. 8A illustrates a process flow depicting a method for controlling operation of the HVAC system, in accordance with one or more embodiments of the disclosure; and

FIG. 8B illustrates a process flow depicting a method for triggering a control action, in accordance with one or more embodiments of the disclosure;

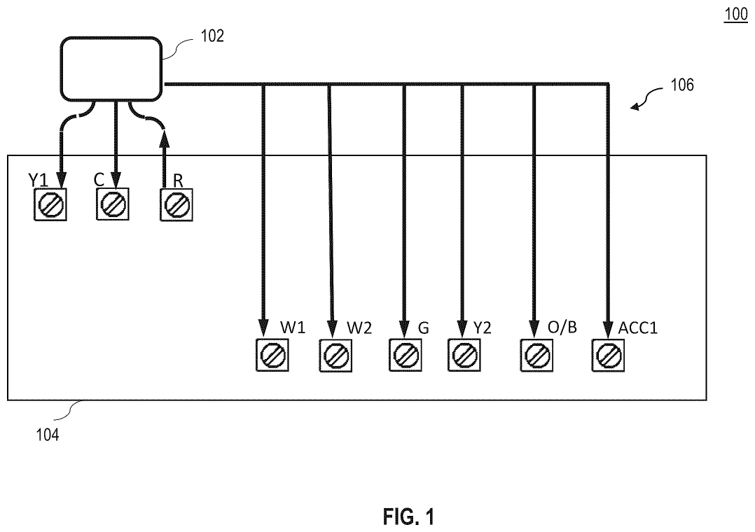

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment”, “some embodiments”, “one or more embodiments” and similar language throughout this specification may but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

In addition to overcoming the challenges related to installation of new wirings, the disclosure provides for a system that allows control boards to perform all the functions of a multi-wire HVAC system using only a three-wire power line between the thermostat and a first HVAC unit, and a two-wire power line between the first HVAC unit and a second HVAC unit. A modern, efficient multi-stage HVAC system may thus be enabled using the existing wirings. No additional wiring needs to be pulled to connect new units and installation time is significantly reduced.

Embodiments of the disclosure will be described below in detail with reference to the accompanying drawings.

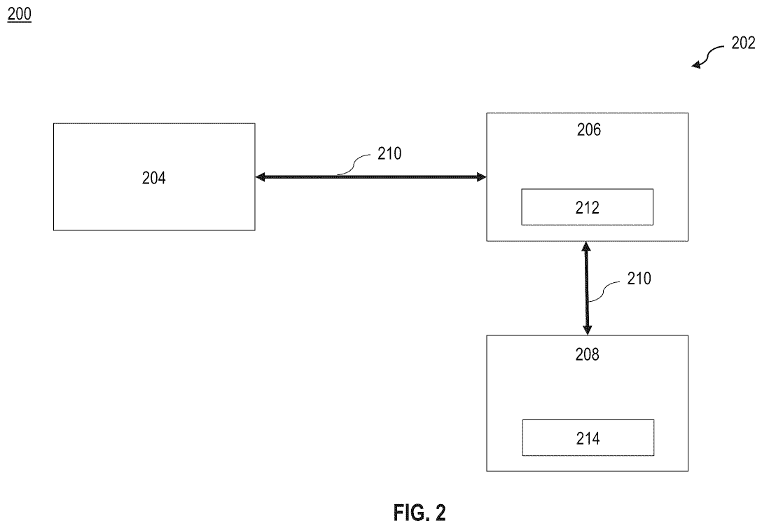

FIG. 2 illustrates an environment 200 comprising a system 202 for controlling operation of an HVAC system associated with one or more HVAC units. The system 202 comprises a thermostat 204, a first HVAC unit 206, and a second HVAC unit 208. The thermostat 204 may be coupled to the first HVAC unit 206 and the second HVAC unit 208 via a power line 210. In an embodiment, the power line 210 may be configured to communicate power signals as well as data signals. In an embodiment, the power line 210 may include 24V wires. In an embodiment, the communication over the power lines 210 may be referred to as power line communication (PLC).

In an embodiment, the power line 210 comprises a common (C) line and an outdoor activation (Y) line. In an embodiment, the power line 210 comprises a C line, a Y line, and a power (R) line. In an embodiment, the power line 210 between the thermostat 204 and the first HVAC unit 206 may comprise the C, Y, and R lines, while the power line 210 between the first HVAC unit 206 and the second HVAC unit 208 comprises C and Y lines. In an embodiment, the power line 210 may be in a powered state and an unpowered state. The power line 210, in particular the Y line, may be enabled to transmit a 24V AC power when required. The power line 210 may further be enabled to transmit data signal in both the powered and the unpowered state of the power line 210. The Y line may be enabled to transmit data or commands irrespective of the state of the power line 210, i.e., in both the powered and the unpowered state of the power line 210.

In an embodiment, the R line may be used to provide power to the HVAC system, such as, via a transformer. In an embodiment, the C line may be used to provide a common connection between the thermostat and one or more components of the HVAC system.

In an embodiment, the first HVAC unit 206 may be an indoor unit (IDU) associated with the HVAC system and the second HVAC unit 208 may be an outdoor unit (ODU) associated with the HVAC system. In an embodiment, the HVAC system may comprise additional components such as a thermostat, zone boards, A2L boards, defrost boards, and the like.

In an embodiment, the first HVAC unit 206 comprises a first control device 212 and functionalities of the first HVAC unit 206 may be provided through the first control device 212. The first control device 212 may be an on-device unit integrated with the first HAVC unit 206. Alternatively, the first control device 212 may be a server-based unit or a cloud-based unit. In some embodiments, one or more components of the first control device 212 may be provided on cloud while one or more components of the first control device 212 may be provided locally on the first HVAC unit 206.

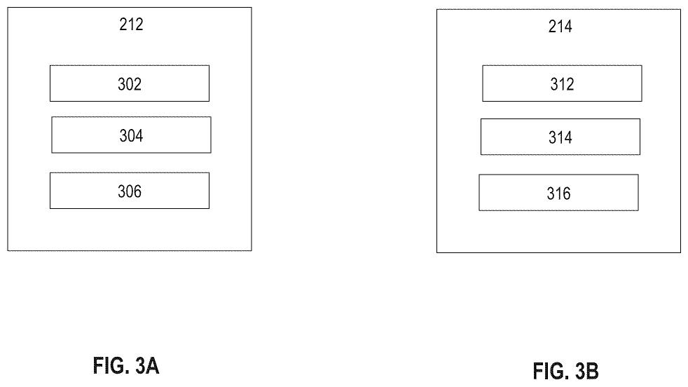

In one or more embodiments, the first control device 212 may comprise one or more processors 302, a memory 304, and a communication interface 306, as shown in FIG. 3A.

The one or more processors 302 may be configured to communicate with the memory 304 to execute programmable instructions stored in the memory 304. The programmable instructions, when executed by the one or more processors 302, cause the one or more processors 302 to provide the functionalities of the first control device 212 as discussed in the disclosure. In one or more embodiments, the one or more processors 302 may be one or more microprocessor(s) or microcontroller(s). The one or more processors 302 may include one or a plurality of processors, which may further include one or more general-purpose processors, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In some embodiments, the memory 304 may store data and instructions executable by the processor(s) 302 to perform the method steps for controlling the operation of the HVAC system, as discussed herein throughout the disclosure. The memory 304 may further include, but is not limited to, a non-transitory computer-readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. Further, the non-transitory computer-readable storage media of memory 304 may include executable instructions in the form of modules and a database to store data. The modules may include a set of instructions that may be executed to cause the one or more processors 302 to perform any one or more of the methods as disclosed herein throughout the disclosure. In one or more embodiments, the modules may be configured to perform the steps of the disclosure using the data stored in the database of the memory 304 for controlling the operation of the HVAC system.

In one or more embodiments, the communication interface 306 may include a transceiver and may be configured to communicate with the thermostat 204 and the second control device 214 via the power line 210. The communication interface 306 may include an electronic circuit specific to a standard that may enable communication over the power line 210.

The first control device 212 may be configured to receive an HVAC signal from the thermostat 204 over the power line 210. The HVAC signal may be associated with an operation to be performed by the HVAC system, for instance, the first HVAC unit 206, the second HVAC unit 208, and other components of the HVAC system. The operation may include, for instance, single-stage cooling, single-stage heating, multistage cooling, multistage heating, fan, etc.

As described above, the power line 210 is configured to communicate the power signal and the data signal. The first control device 212 may be configured to determine whether the HVAC signal received over the power line 210 is indicative of the power signal or the data signal. In an embodiment, the HVAC signal may be a power signal to provide power to the first HVAC unit 206 and/or to other components of the HVAC system. In an embodiment, the HVAC signal may be a data signal including details of the operation to be performed by the HVAC system, such as an operation to be performed by the first HVAC unit 206. In an embodiment, the data signal may be received over the Y line.

The first control device 212 may be configured to determine that the HVAC signal is indicative of the data signal, and upon determining that the HVAC signal is indicative of the data signal, the first control device 212 may be configured to trigger a control action associated with the HVAC system. That is, the first control device 212 may be configured to monitor various HVAC signals from the thermostat 204, such as, signals for cooling, heating, fan, and the like.

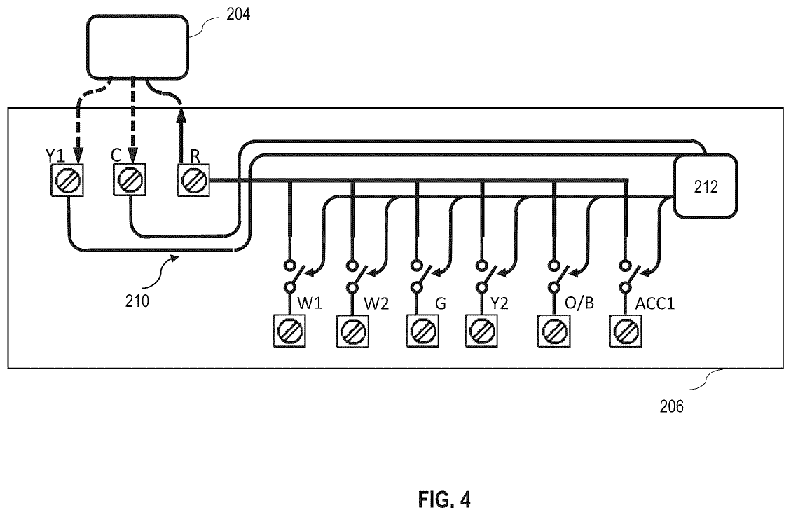

Referring to FIG. 4, a schematic representation of a HVAC system is depicted, in which, the first HVAC unit 206 is in communication with the thermostat 204 over the power line 210, such as, Y, C, and R lines. In an embodiment, the data signal may be received over the Y line. The first HVAC unit 206 comprises the first control device 212 configured to receive HVAC signals from the thermostat 204.

In an embodiment, the first HVAC unit 206 may comprise a set of relays 402 associated with corresponding functions of the first HVAC unit 206. The set of relays 402 (may be referred to as a ‘first set of relays’) may be associated with the cooling functions, heating functions, fan functions, and the like of the first HVAC unit 206. Each relay of the set of relays may be switched between an open state and a close state. When the corresponding relay is in the closed state, the corresponding function may be performed by the first HVAC unit 206. When the corresponding relay is in the open state, the corresponding function may not be performed by the first HVAC unit 206.

As described above, the first control device 212 may be configured to trigger a control action associated with the HVAC system. In an embodiment, the control action may include an activation or a de-activation, i.e., closing or opening, of the set of relays 402. The first control device 212 may be configured to determine, based on the data signal, the operation to be performed by the HVAC system. The first control device 212 may then be configured to cause an activation or a de-activation of one or more relays of the set of relays 402 of the first HVAC unit 206. Accordingly, based on the received data signal, the corresponding functionality of the first HVAC unit 206 may be activated or de-activated by controlling the set of relays 402. As an example, the HVAC signal over the power line may include a data signal indicative of a command for first-stage cooling. In an embodiment, the data signal may be received over the Y line. The first control device 212 may detect the HVAC signal and decode the data (command for first-stage cooling). The first control device 212 may then activate the corresponding relay of the set of relays 402 to activate the first stage cooling by the first HVAC unit 206.

In an embodiment, the first control device 212 may comprise a set of terminals corresponding to the functions of the first HVAC unit 206. The first control device 212 may be configured to determine, based on the received data signal, the operation to be performed by the HVAC system. The first control device 212 may then be configured to control the set of terminals to perform the operation through the functions of the first HVAC unit 206. In particular, the first control device 212 may be configured to generate a switching signal to cause activation or de-activation of one or more terminals of the set of terminals. Based on the activation or de-activation of the one or more terminals, the corresponding functions of the first HVAC unit 206 may be performed or stopped. As an example, the HVAC signal over the power line 210 may include a data signal indicative of a command for multistage cooling. In an embodiment, the data signal may be received over the Y line. The first control device 212 may detect the HVAC signal and decode the data (command for multistage cooling). The first control device 212 may then energize the corresponding terminal to activate the multistage cooling by the first HVAC unit 206.

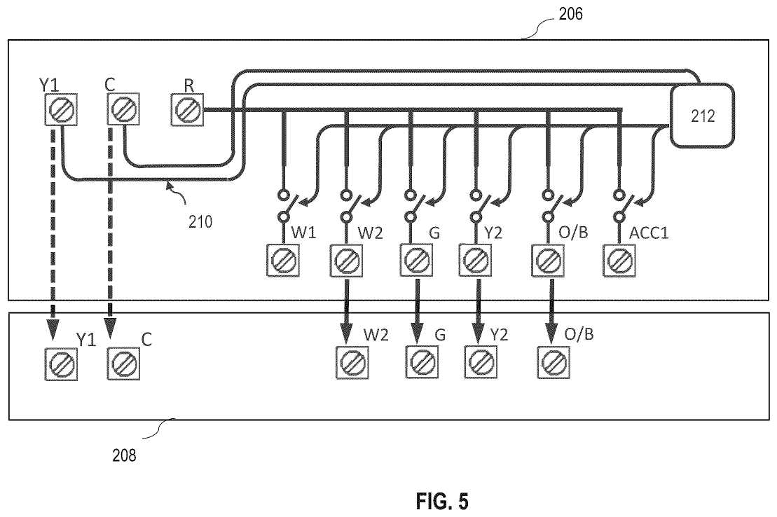

As described above, the first control device 212 may be configured to trigger the control action associated with the HVAC system. In an embodiment, the control action may include controlling the operation of the second HVAC unit 208. Referring to FIG. 5, another schematic representation of a HVAC system is depicted. The first HVAC unit 206 is in communication with the thermostat 204 over the power line 210, such as, Y, C, and R lines. The first HVAC unit 206 may be in communication with the second HVAC unit 208 over the power line 210, such as, the Y and C lines.

The second HVAC unit 208 may comprise a set of relays 502 associated with the corresponding functions of the second HVAC unit 208. The set of relays 502 (may be referred to as a ‘second set of relays’) may be associated with the cooling functions, heating functions, fan functions, and the like of the second HVAC unit 208. Each relay of the set of relays 502 may be switched between an open state and a closed state. Similar to the set of relays 402, when the corresponding relay is in the closed state, the corresponding function may be performed by the second HVAC unit 208, and when the corresponding relay is in the open state, the corresponding function may not be performed by the second HVAC unit 208.

The first control device 212 may be configured to determine, based on the received data signal, the operation to be performed by the HVAC system. The first control device 212 may be configured to decode the data signal and determine that an operation is to be performed by the second HVAC unit 208. The first control device 212 may be configured to cause activation or de-activation of one or more relays of the set of relays 502 of the second HVAC unit 208 based on the data signal.

In an embodiment, the second HVAC unit 208 may comprise a set of screw terminals instead of the set of relays 502, and the details provided above with respect to the set of relays are applicable to the set of screw terminals as well. In an embodiment, the set of screw terminals may be configured to facilitate electrical connection via electric wires.

Accordingly, based on the received data signal, the corresponding functionality of the second HVAC unit 208 may be controlled by the first HVAC unit 206. That is, the first HVAC unit 206 may decode the received data and control an activation or a de-activation of corresponding functions of the second HVAC unit, by controlling the set of relays or the set of screw terminals of the second HVAC unit 208. As an example, the HVAC signal over the power line may be indicative of a command for first stage cooling. In an embodiment, the command may be received over the Y line. The first control device 212 may detect the HVAC signal and decode the data (command for first stage cooling). The first control device 212 may then activate the corresponding relay of the set of relays 502 to activate the first-stage cooling by the second HVAC unit 208.

In an embodiment, the second HVAC unit 208 comprises a second control device 214 and functionalities of the second HVAC unit 208 may be provided through the second control device 214. The second control device 214 may be an on-device unit integrated with the second HAVC unit 208. Alternatively, the second control device 214 may be a server-based unit or a cloud-based unit. In some embodiments, one or more components of the second control device 214 may be provided on cloud while one or more components of the second control device 214 may be provided locally on the second HVAC unit 208.

In one or more embodiments, the second control device 214 may comprise one or more processors 312, a memory 314, and a communication interface 316, as shown in FIG. 3B. It is appreciated that the details provided above for the one or more processors 302, the memory 314, and the communication interface 316 are equally applicable for the one or more processors 312, the memory 314, and the communication interface 316.

In one or more embodiments, the communication interface 316 may include a transceiver and may be configured to communicate with the thermostat 204 and the first control device 212 via the power line 210. For instance, the communication interface 316 may enable the second control device 214 to receive data signals from the first control device 212. The communication interface 316 may include an electronic circuit specific to a standard that may enable communication over the power line 210.

As described above, the first control device 212 may be configured to receive the HVAC signal comprising the data signal from the thermostat 204. In an embodiment, the first control device 212 may trigger the control action to control the operation of the second HVAC unit 208. The first control device 212 may be configured to determine the operation to be performed by the HVAC system based on the data signal. For instance, the operation may include first stage cooling in which the activation of corresponding functions of the first HVAC unit 206 and the second HVAC unit 208 may be required. The first control device 212 may be configured to activate/energize the corresponding relays or terminals to enable the first HVAC unit 206 to perform the corresponding function (in this example, the first stage cooling).

As the second HVAC unit 208 is also required to perform a function (first stage cooling), the first control device 212 may be configured to convert the data signal into another data signal indicative of a command for the second HVAC unit 208. The first control device 212 may be configured to transmit the another data signal to the second control device 214 over the power line 210. In an embodiment, the power line 210 between the first HVAC unit 206 and the second HVAC unit 208 may comprise Y and C lines. In an embodiment, various HVAC signals from the thermostat 204 may refer to energized or de-energized signals, and the another data signal may refer to a digital representation of the energized or de-energized signals.

Based on the another data signal received from the first control device 212, the second control device 214 may be configured to activate or de-activate one or more terminals associated with the second HVAC unit 208. That is, the first control device 212 enables the second control device 214 to activate or de-activate the one or more terminals to facilitate the operation to be performed by the HVAC system, in this example, the first stage cooling. Accordingly, based on the data signal received from the thermostat 204, the first HVAC unit 206 and the second HVAC unit 208 may perform the required functions.

In an embodiment, the first control device 212 and the second control device 214 may be configured to simultaneously receive the HVAC signal from the thermostat 204. The HVAC signal may be received over the power line 210 and may be associated with the operation to be performed by the HVAC system. Based on the received HVAC signal, the first control device 212 may be configured to generate a first switching signal to cause at least one of activation or deactivation of one or more respective terminals associated with the first HVAC unit 206. Further, based on the received HVAC signal, the second control device 214 may be configured to generate a second switching signal to cause at least one of activation or deactivation of one or more respective terminals associated with the second HVAC unit 208. That is, respective switching signals may be generated by the first control device 212 and the second control device 214 to cause at least one of an activation or a deactivation of one or more respective terminals associated with the first HVAC unit 206 and the second HVAC unit 208, in order to facilitate the operation to be performed by the HVAC system.

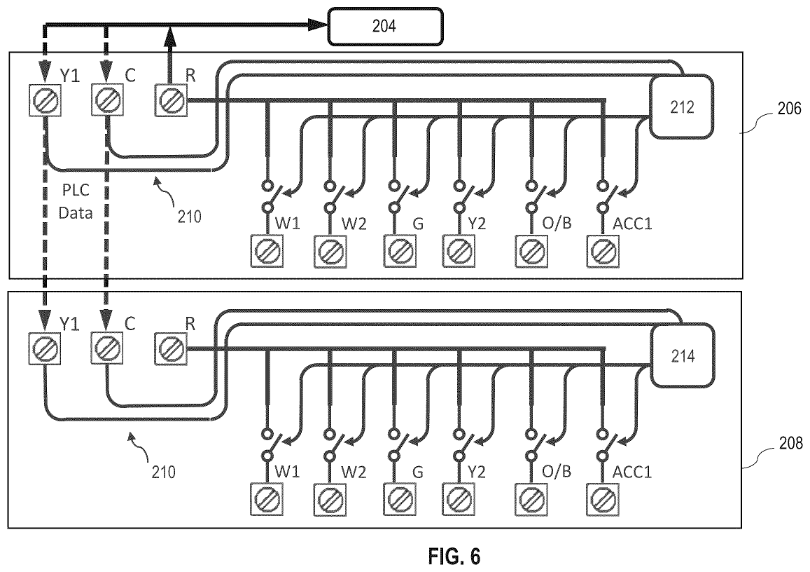

Reference is made to FIG. 6, which illustrates another schematic representation of a HVAC system, in accordance with an embodiment of the disclosure. The first HVAC unit 206 may comprise a first set of relays 602 (corresponding to set of relays 402 in FIG. 4) and the second HVAC unit 208 may comprise a second set of relays 604 (corresponding to set of relays 502 in FIG. 5). As seen in FIG. 6, an HVAC signal may be received from the thermostat 204. The HVAC signal may include a data signal or a power signal. The first control device 212 may be configured to receive the HVAC signal and determine the operation to be performed. The first control device 212 may be configured to control the first set of relays 602 associated with corresponding functions of the first HVAC unit 206 based on the operation to be performed by the HVAC system. In an embodiment, the first control device 212 may be configured to generate the first switching signal to activate or de-activate the first set of relays 602. As an example, the operation may be activation of first stage cooling. The first control device 212 may activate the corresponding relay of the first set of relays 602 to cause the first HVAC unit 206 to perform the operation of first stage cooling.

In an embodiment, the first control device 212 may be configured to send another data signal to the second control device 214, the another data signal being indicative of the command for the second control device 214. Based on the received another data signal, the second control device 214 may control the second set of relays 604 associated with corresponding functions of the second HVAC unit 208 based on the operation to be performed by the HVAC system. As per the above-mentioned example, the second control device 214 may activate the corresponding relay of the second set of relays 604 to cause the second HVAC unit 208 to perform the operation of first stage cooling.

In an embodiment, the second control device 214 may simultaneously receive the HVAC signal from the thermostat 204 over the power line 210. The second control device 214 may be configured to generate the second switching signal to activate or de-activate the second set of relays 604. As per the above example, the operation may be activation of first stage cooling and the second control device 214 may activate the corresponding relay of the second set of relays 604 to cause the second HVAC unit 208 to perform the operation of first stage cooling.

It is appreciated that although FIG. 6 has been described with reference to the set of relays 602, 604, the details are applicable for an embodiment where the first HVAC unit 206 and the second HVAC unit 208 comprise a respective set of terminals energized and de-energized by the first control device 212 and the second control device 214.

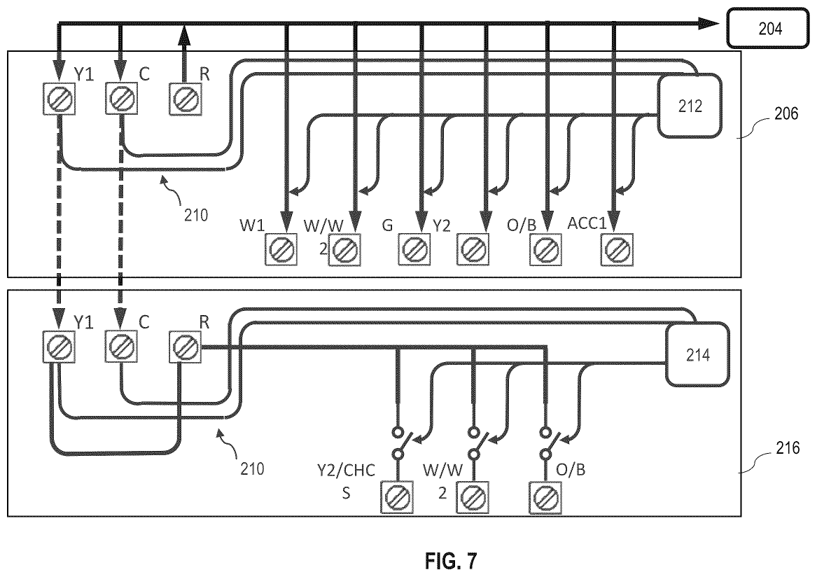

In an embodiment, the HVAC system may comprise the thermostat 204 and the first HVAC unit 206. A new second HVAC unit may be retrofitted to the HVAC system. Referring to FIG. 7, another schematic representation of a HVAC system is depicted, in accordance with an embodiment of the disclosure. The new second HVAC unit 216 may be in communication with the first HVAC unit 206 and/or the thermostat 204. The thermostat 204 may be configured to transmit standard 24 v signals as well as data signals to the first HVAC unit 206. The first control device 212 may be configured to convert the signals from the thermostat 204 into digital signals, or the another data signal, indicative of commands for the new second HVAC unit 216. In an embodiment, the new second HVAC unit may require additional number of signals for operation. As the first control device 212 generates the another data signal, the second control device 214 of the new second HVAC unit 216 may receive the another data signal and control the operation of the new second HVAC unit 216. As a result, even with the new second HVAC unit requiring additional number of signals than already installed wirings can provide, with the system as detailed herein, commands can be sent to the new second HVAC unit 216 over the power line 210 and the operation of the new second HVAC unit 216 can be performed without requiring installation of additional wirings. In a non-limiting example, the new second HVAC unit 216 may be a heat pump. In an embodiment, the new second HVAC unit 216 may be a humidifier, a de-humidifier, an air purifier, and the like.

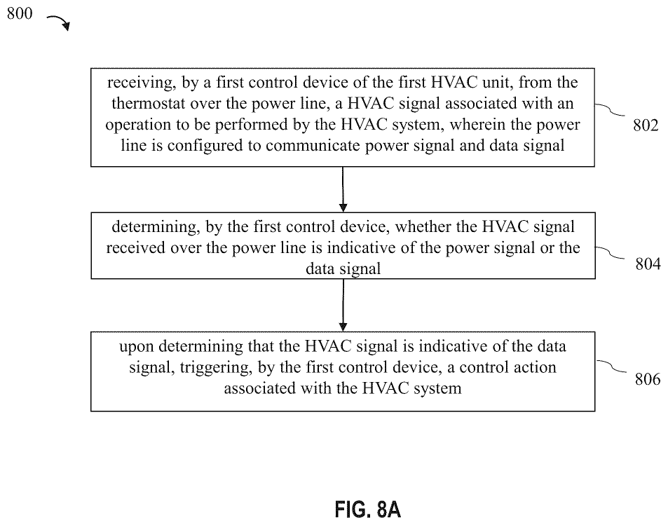

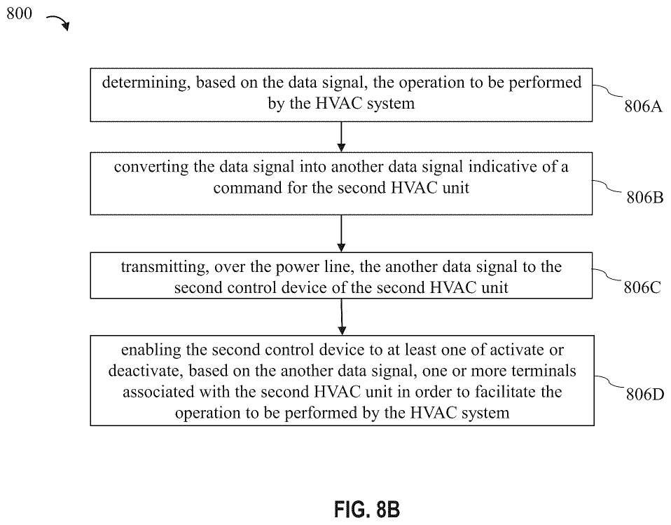

FIG. 8A illustrates a process flow depicting a method 800 for controlling operation of the HVAC system comprising the thermostat 204 and the first HVAC unit 206 coupled via the power line 210. The method 800 may be described with reference to the first HVAC unit 206, and a skilled person will appreciate that the method may be performed for multiple units within the HVAC system. In an embodiment, the method 800 may be performed by the first control device 212 of the first HVAC unit 206.

At step 802, the method 800 comprises receiving from the thermostat over the power line 210, a HVAC signal associated with an operation to be performed by the HVAC system. The power line 210 may be configured to communicate power signal and data signal.

At step 804, the method 800 comprises determining whether the HVAC signal received over the power line 210 is indicative of the power signal or the data signal.

At step 806, the method comprises triggering a control action associated with the HVAC system upon determining that the HVAC signal is indicative of the data signal.

In some embodiments, triggering the control action comprises causing the activation or de-activation of a set of terminals associated with the first HVAC unit 206. In some embodiments, triggering the control action comprises controlling a set of relays associated with the HVAC unit 206. In some embodiments, triggering the control action comprises causing the activation or de-activation of a set of terminals associated with the second HVAC unit 208.

In some embodiments, in triggering the control action, the method 800 comprises sub-steps 806A-806D, as depicted in FIG. 8B. At step 806A, the method 800 comprises determining, based on the data signal, the operation to be performed by the HVAC system.

At step 806B, the method 800 comprises converting the data signal into another data signal indicative of a command for the second HVAC unit 208.

At step 806C, the method 800 comprises transmitting, over the power line 210, the another data signal to the second control device 214 of the second HVAC unit 208.

At step 806D, the method 800 comprises enabling the second control device 214 to at least one of activate or deactivate, based on the another data signal, one or more terminals associated with the second HVAC unit 208 in order to facilitate the operation to be performed by the HVAC system.

In some embodiments, triggering the control action comprises simultaneously receiving, by the first control device 212 and the second control device 214 over the power line 210, the HVAC signal associated with the operation to be performed by the HVAC system. In some embodiments, triggering the control action further comprises generating, by the first control device 212 and the second control device 214, respective switching signals to cause at least one of an activation or a deactivation of one or more respective terminals associated with the first HVAC unit 206 and the second HVAC unit 208, in order to facilitate the operation to be performed by the HVAC system.

While the above steps of FIGS. 8A-8B are shown and described in a particular sequence, the steps may occur in variations to the sequence in accordance with various embodiments of the disclosure. Further, a detailed description related to the various steps of FIGS. 8A-8B is already covered in the description related to FIGS. 2-7 and is omitted herein for the sake of brevity.

In some embodiments, the first control device 212 and/or the second control device 214 may be configured to execute instructions included in a computer program product. The computer program product may be embodied on a non-transitory computer-readable medium. The computer program product may comprise instructions that, when executed by the first control device 212 and/or the second control device 214, cause the first control device 212 and/or the second control device 214 to perform the method steps are detailed with reference to FIGS. 8A-8B.

The disclosure provides a virtualized HVAC system comprising HVAC units, such as the first HVAC unit and the second HVAC unit. The virtualization of the HVAC system is characterized by the HVAC units being controlled via signals including energizing or deenergizing the 24 vac power of the Y line, by PLC communication carried over the Y line, or by both, either separate or simultaneously. One or both of the first HVAC unit and the second HVAC unit may be virtualized. With the virtualization, the HVAC units may be backward compatible with standard 24 v equipment. For instance, a virtualized IDU may be in communication with a standard ODU, a virtualized ODU may be in communication with a standard IDU, and both the IDU and the ODU may be virtualized.

A control device, such as the first control device, may monitor the HVAC signals from the thermostat. The control device may send data over Y wire to either:
1) the second control device of a virtualized second HVAC unit.
2) the second control device integrated with a standard second HVAC unit.

The disclosure allows the addition of new HVAC units to the already installed HVAC system without requiring new wirings. For instance, single stage, two-stage, and multi-stage heat pump units can be added using only the already installed wirings of the HVAC system. As a result, installation time is significantly reduced.

As an example, W/W1, W2, Y/Y1, Y2, G, O/B, ACC1, ACC2, DEHUM, and other signals can be virtualized. The signals can be energized and de-energized based on the data received over the Y wire. Moreover, when a new unit requiring additional signals is to be attached to the existing HVAC system, the need for installing separate wiring for the additional signals is eliminated. This is because the additional signal can be directed to a corresponding terminal of the control device(s) based on signals from the Y wire.

Moreover, without the need to connect to standard legacy units, the relays can be eliminated and the HVAC signals can be directed to the corresponding terminals of the control device(s).

The control boards (first control board and/or the second control board) of the HVAC system may thus perform all the functions of a multi-wire HVAC system using only there wires between the thermostat and the first HVAC unit, and only two wires between the first HVAC unit and the second HVAC unit. A modern, efficient multi-stage HVAC system may thus be enabled using the existing wirings. No additional wiring needs to be pulled to connect new units.

Further, the number of signal connectors on the first HVAC unit and/or the second HVAC unit can be easily dynamically increased or decreased. With only three wires (Y, C, and R lines), the entire HVAC system can be virtualized. Integrating the control device(s) on the HVAC units reduces the number of wires needed for a complete system to only three wires.

As would be apparent to a person in the art, various working modifications may be made to the methods disclosed herein in order to implement the inventive concept as taught herein.

Moreover, the actions of any flow diagram need not be implemented in the order shown; nor do all of the acts necessarily need to be performed. Also, those acts that are not dependent on other acts may be performed in parallel with the other acts.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A method for controlling operation of a heating, ventilation, and air conditioning (HVAC) system comprising a thermostat and a first HVAC unit coupled via a power line, the method comprising:
receiving, by a first control device of the first HVAC unit, from the thermostat over the power line, a HVAC signal associated with an operation to be performed by the HVAC system, wherein the power line is configured to communicate power signal and data signal;
determining, by the first control device, whether the HVAC signal received over the power line is indicative of the power signal or the data signal; and
upon determining that the HVAC signal is indicative of the data signal, triggering, by the first control device, a control action associated with the HVAC system.

2. The method of claim 1, wherein triggering the control action comprises:
determining, based on the data signal, the operation to be performed by the HVAC system; and
generating a switching signal to cause at least one of an activation or a deactivation of one or more terminals associated with the first HVAC unit in order to facilitate the operation to be performed by the HVAC system.

3. The method of claim 1, wherein triggering the control action comprises:
determining, based on the data signal, the operation to be performed by the HVAC system; and
causing at least one of an activation or a de-activation of one or more relays of a first set of relays associated with the first HVAC unit.

4. The method of claim 1, wherein the HVAC system comprises a second HVAC unit, and wherein triggering the control action comprises:
determining, based on the data signal, the operation to be performed by the HVAC system; and
causing at least one of an activation or a de-activation of one or more of a second set of relays associated with the second HVAC unit.

5. The method of claim 1, wherein the HVAC system comprises a second HVAC unit associated with a second control device, and wherein triggering the control action comprises:
determining, based on the data signal, the operation to be performed by the HVAC system;
converting the data signal into another data signal indicative of a command for the second HVAC unit;
transmitting, over the power line, the another data signal to the second control device of the second HVAC unit; and
enabling the second control device to at least one of activate or deactivate, based on the another data signal, one or more terminals associated with the second HVAC unit in order to facilitate the operation to be performed by the HVAC system.

6. The method of claim 1, wherein the HVAC system comprises a second HVAC unit associated with a second control device, and wherein triggering the control action comprises:
simultaneously receiving, by the first control device and the second control device over the power line, the HVAC signal associated with the operation to be performed by the HVAC system; and
generating, by the first control device and the second control device, a first switching signal and a second switching signal respectively to cause at least one of an activation or a deactivation of one or more respective terminals associated with the first HVAC unit and the second HVAC unit, in order to facilitate the operation to be performed by the HVAC system.

7. The method of claim 1, wherein:
the power line is associated with a powered state and an unpowered state, and
the power line is configured to communicate the data signal in the powered state and in the unpowered state.

8. The method of claim 5, wherein the first HVAC unit is an indoor unit (IDU) associated with the HVAC system and the second HVAC unit is an outdoor unit (ODU) associated with the HVAC system.

9. The method of claim 1, wherein the power line comprises at least one of a common (C) line and an outdoor activation (Y) line.

10. A system for controlling operation of a heating, ventilation, and air conditioning (HVAC) system comprising:
a thermostat; and
a first HVAC unit coupled to the thermostat via a power line, the first HVAC unit comprising a first control device configured to:
receive, from the thermostat over the power line, a HVAC signal associated with an operation to be performed by the HVAC system, wherein the power line is configured to communicate power signal and data signal;
determine whether the HVAC signal received over the power line is indicative of the power signal or the data signal; and
upon the determination that the HVAC signal is indicative of the data signal, trigger a control action associated with the HVAC system.

11. The system of claim 10, wherein to trigger the control action, the first control device is configured to:
determine, based on the data signal, the operation to be performed by the HVAC system; and
generate a switching signal to cause at least one of an activation or a deactivation of one or more terminals associated with the first HVAC unit in order to facilitate the operation to be performed by the HVAC system.

12. The system of claim 10, wherein to trigger the control action, the first control device is configured to:
determine, based on the data signal, the operation to be performed by the HVAC system; and
cause at least one of an activation or a de-activation of one or more relays of a first set of relays associated with the first HVAC unit.

13. The system of claim 10, wherein the HVAC system comprises a second HVAC unit, and wherein to trigger the control action, the first control device is configured to:
determine, based on the data signal, the operation to be performed by the HVAC system; and
cause at least one of an activation or a de-activation of one or more of a second set of relays associated with the second HVAC unit.

14. The system of claim 10, wherein the HVAC system comprises a second HVAC unit associated with a second control device, and wherein to trigger the control action, the first control device is configured to:
determine, based on the data signal, the operation to be performed by the HVAC system;
convert the data signal into another data signal indicative of a command for the second HVAC unit;
transmit, over the power line, the another data signal to the second control device of the second HVAC unit; and
enable the second control device to at least one of activate or deactivate, based on the another data signal, one or more terminals associated with the second HVAC unit in order to facilitate the operation to be performed by the HVAC system.

15. The system of claim 10, wherein the HVAC system comprises a second HVAC unit associated with a second control device,
wherein to trigger the control action, the first control device is configured to:
receive, over the power line, the HVAC signal associated with the operation to be performed by the HVAC system, and
generate a first switching signal to cause at least one of an activation or a deactivation of one or more respective terminals associated with the first HVAC unit, in order to facilitate the operation to be performed by the HVAC system, and
wherein the second control device is configured to:
simultaneously receive, over the power line, the HVAC signal associated with the operation to be performed by the HVAC system, and
generate a second switching signal to cause at least one of an activation or a deactivation of one or more respective terminals associated with the second HVAC unit, in order to facilitate the operation to be performed by the HVAC system.

16. The system of claim 10, wherein:
the power line is associated with a powered state and an unpowered state, and
the power line is configured to communicate the data signal in the powered state and in the unpowered state.

17. The system of claim 14, wherein the first HVAC unit is an indoor unit (IDU) associated with the HVAC system and the second HVAC unit is an outdoor unit (ODU) associated with the HVAC system.

18. The system of claim 10, wherein the power line comprises at least one of a common (C) line and an outdoor activation (Y) line.
